(19) United States
(12) Patent Application Publication
(10) Pub. No.: US 2016/0142420 A1
(43) Pub. Date: May 19, 2016

(54) METHOD AND SYSTEM FOR DYNAMICALLY CONTROLLING A REMOTE TERMINAL BASED ON RUNTIME AUTHORIZATION AND RULES

(71) Applicants: VINOD GUPTA, FREMONT, CA (US); ABHIJIT KHINVASARA, LOS ALTOS, CA (US)

(72) Inventors: VINOD GUPTA, FREMONT, CA (US); ABHIJIT KHINVASARA, LOS ALTOS, CA (US)

(73) Assignee: SWACHO INC., LOS ALTOS, CA (US)

(21) Appl. No.: 14/542,266

(22) Filed: Nov. 14, 2014

(51) Int. Cl. H04L 29/06; H04L 12/58; H04L 29/08

(52) U.S. Cl. CPC H04L 63/105; H04L 67/42; H04L 67/10; H04L 51/04

(57) ABSTRACT

A content validation server is provided. The server can include at least one processor and a memory operatively coupled to the processor, the memory storing program instructions that when executed by the processor, causes the processor to perform a number of processes. These processes can include receiving a uniform resource locator from a client device and generating a recommendation for the uniform resource locator. In addition, the processes can include providing the recommendation to an administrator device and receiving a response from the administrator device based on the recommendation. The processes can also include allowing or denying access to the uniform resource locator for the client device based on the response.

### TECHNICAL FIELD

This disclosure generally relates to communications, and more particularly, to administering runtime authorizations and rules to content accessed by a device.

### BACKGROUND

Today, access to information on the World Wide Web can be obtained from a variety of devices. This technology can provide significant benefits along with certain challenges especially to young children who can be exposed to harmful content. To reduce the amount of harmful content presented to a user, white lists have been generated. These white lists can contain a registration of sites that have been preapproved for viewing. When accessed through a device, the white list can be referenced and a site can be approved. Oppositely, black lists can be used to indicate content which cannot be viewed.

Other methods for monitoring a user include limiting the amount of time a terminal can view the content. Dynamic authorization techniques can also be used by installing software which notifies a supervisor through services like SMS, email, and app notifications when inappropriate content is being viewed.

As shown, the available methods existing today can provide a static list of content that is either approved or black listed. These methods often times require a tedious process of installing special software on a terminal. Furthermore, there is no dash board functionality to review what a child is viewing when a supervisor or administrator is remotely available. When a supervisor is not available, systems can fail to react. As such, a method and system for dynamically controlling a remote terminal based on runtime authorization and rules is needed.

### BRIEF DESCRIPTION

According to one aspect of the present disclosure, a method for approving content being accessed on a device is provided. The method can include receiving a request to access the content from the device and allowing access to the content when a record associated with the device shows approval of the content and blocking access to the content when the record shows disapproval of the content. In addition, the method can include retrieving a recommendation to access the content when the record is silent to the content and providing the recommendation to an administrator device. The method can also include receiving a response from the administrator device based on the recommendation and allowing access to the content when the response shows approval of the content and blocking access to the content when the response shows disapproval of the content.

According to another aspect of the present disclosure, a system for monitoring content is provided. The system can include a client device accessing the content through a uniform resource locator. In addition, the system can include a validation server receiving the uniform resource locator from the client device and providing a recommendation regarding the content referenced by the uniform resource locator. The system can also include an administrator device receiving the recommendation and providing the client device through the validation server with a response based on the recommendation, the response indicating whether the content referenced by the uniform resource locator has been approved or disapproved.

According to a further aspect, a content validation server is provided. The server can include at least one processor and a memory operatively coupled to the processor, the memory storing program instructions that when executed by the processor, causes the processor to perform a number of processes. These processes can include receiving a uniform resource locator from a client device and generating a recommendation for the uniform resource locator. In addition, the processes can include providing the recommendation to an administrator device and receiving a response from the administrator device based on the recommendation. The processes can also include allowing or denying access to the uniform resource locator for the client device based on the response.

### BRIEF DESCRIPTION OF DRAWINGS

The novel features believed to be characteristic of the disclosure are set forth in the appended claims. In the descriptions that follow, like parts are marked throughout the specification and drawings with the same numerals, respectively. The drawing FIGURES are not necessarily drawn to scale and certain FIGURES can be shown in exaggerated or generalized form in the interest of clarity and conciseness. The disclosure itself, however, as well as a preferred mode of use, further objectives and advantages thereof, will be best understood by reference to the following detailed description of illustrative embodiments when read in conjunction with the accompanying drawings, wherein:

FIG. 1 is a block diagram illustrating an exemplary system for validating content referenced by a uniform resource locator in accordance with one aspect of the present disclosure;

FIG. 2 is a block diagram illustrating an exemplary client device or administrator device within the system in accordance with one aspect of the present disclosure;

FIG. 3 is a flow chart illustrating processes for validating the uniform resource locator on the client device in accordance with one or more aspects of the present disclosure;

FIG. 4 is a flow chart illustrating processes for validating the uniform resource locator on the validation server in accordance with one or more aspects of the present disclosure; and

FIG. 5 is a flow chart illustrating processes for validating the uniform resource locator on the administrator device in accordance with one or more aspects of the present disclosure.

### DESCRIPTION OF THE DISCLOSURE

The description set forth below in connection with the appended drawings is intended as a description of presently preferred embodiments of the disclosure and is not intended to represent the only forms in which the present disclosure can be constructed and/or utilized. The description sets forth the functions and the sequence of steps for constructing and operating the disclosure in connection with the illustrated embodiments. It is to be understood, however, that the same or equivalent functions and sequences can be accomplished by different embodiments that are also intended to be encompassed within the spirit and scope of this disclosure.

The following includes definitions of selected terms employed herein. The definitions include various examples and/or forms of components that fall within the scope of a term and that can be used for implementation. The examples are not intended to be limiting.

A “bus,” as used herein, refers to an interconnected architecture that is operably connected to other computer components inside a computer or between computers. The bus can transfer data between the computer components. The bus can be a memory bus, a memory controller, a peripheral bus, an external bus, a crossbar switch, and/or a local bus, among others.

“Computer communication,” as used herein, refers to a communication between two or more computing devices (e.g., computer, personal digital assistant, cellular telephone, network device) and can be, for example, a network transfer, a file transfer, an applet transfer, an email, a hypertext transfer protocol (HTTP) transfer, and so on. A computer communication can occur across, for example, a wireless system (e.g., IEEE 802.11), an Ethernet system (e.g., IEEE 802.3), a token ring system (e.g., IEEE 802.5), a local area network (LAN), a wide area network (WAN), a point-to-point system, a circuit switching system, a packet switching system, among others.

A “disk,” as used herein can be, for example, a magnetic disk drive, a solid state disk drive, a floppy disk drive, a tape drive, a Zip drive, a flash memory card, and/or a memory stick. Furthermore, the disk can be a CD-ROM (compact disk ROM), a CD recordable drive (CD-R drive), a CD rewritable drive (CD-RW drive), and/or a digital video ROM drive (DVD ROM). The disk can store an operating system that controls or allocates resources of a computing device.

A “database,” as used herein can refer to table, a set of tables, a set of data stores and/or methods for accessing and/or manipulating those data stores. Some databases can be incorporated with a disk as defined above.

A “memory,” as used herein can include volatile memory and/or non-volatile memory. Non-volatile memory can include, for example, ROM (read only memory), PROM (programmable read only memory), EPROM (erasable PROM), and EEPROM (electrically erasable PROM). Volatile memory can include, for example, RAM (random access memory), synchronous RAM (SRAM), dynamic RAM (DRAM), synchronous DRAM (SDRAM), double data rate SDRAM (DDR SDRAM), and direct RAM bus RAM (DRRAM). The memory can store an operating system that controls or allocates resources of a computing device.

A “module,” as used herein, includes, but is not limited to, non-transitory computer readable medium that stores instructions, instructions in execution on a machine, hardware, firmware, software in execution on a machine, and/or combinations of each to perform a function(s) or an action(s), and/or to cause a function or action from another module, method, and/or system. A module may also include logic, a software controlled microprocessor, a discrete logic circuit, an analog circuit, a digital circuit, a programmed logic device, a memory device containing executing instructions, logic gates, a combination of gates, and/or other circuit components. Multiple modules may be combined into one module and single modules may be distributed among multiple modules.

An “operable connection,” or a connection by which entities are “operably connected,” is one in which signals, physical communications, and/or logical communications can be sent and/or received. An operable connection can include a wireless interface, a physical interface, a data interface, and/or an electrical interface.

A “processor,” as used herein, processes signals and performs general computing and arithmetic functions. Signals processed by the processor can include digital signals, data signals, computer instructions, processor instructions, messages, a bit, a bit stream, or other means that can be received, transmitted and/or detected. Generally, the processor can be a variety of various processors including multiple single and multicore processors and co-processors and other multiple single and multicore processor and co-processor architectures. The processor can include various modules to execute various functions.

A “server”, as used herein, is a computer or program that responds to commands from a client through the Internet or other network. A server program on a computer in a distributed network can handle business logic between users and backend business applications or data bases. Servers can provide transaction management, failure and load balancing. A server can be viewed as part of a three tier application consistent of a front end GUI server such as an HTTP server, an application server and a back end database and transaction server. A server may contain data or program files. The server may connect with databases that are either local or remote from the server.

Generally described, the systems and methods discussed herein are directed to approving content being accessed by a device. A number of authentication and validation services can be used for approving the content. These can include, but are not limited to, a records database maintaining approved and disapproved content. Other services can include a recommendation engine in addition to an administrator device for approving the content.

A number of advantages can be provided using the systems and methods described herein. Dynamic lists of approved or black listed content can be generated. Furthermore, real-time authorization services can be given with recommended courses of action. Other advantages will become apparent from the description provided below. FIGS. 1 and 2 represent illustrative functional blocks of the system while FIGS. 3 through 5 represent flow charts showing processes for each of the client device, server, and administrator device in the system.

With reference now to FIG. 1, a block diagram illustrating an exemplary system 100 for validating content referenced by a uniform resource locator in accordance with one aspect of the present disclosure is provided. Throughout this disclosure, a uniform resource locator is discussed for accessing content. While content can be accessed through a uniform resource locator, the content can also be sent to the server directly for approval. Furthermore, other types of content can be verified through the systems and methods of the present disclosure. Further details will be disclosed in the written description along with the FIGURES presented below.

The system 100 can include a client device 102, validation server 104, and an administrator device 106, but is not necessarily limited to these components. For example, and as will become apparent, more than one administrator device 106 can be used within the system 100. Furthermore, multiple client devices 102 can be linked with a specific user. The validation server 104 can also be split into multiple components.

While not shown, the components within the system 100 can be connected through a network. Components can communicate with one another through the network in an operable connection. The network can include a local area network, wide area network, personal area network, campus area network, metropolitan area network, global area network, or a combination thereof.

Before describing the validation server 104 of FIG. 1, the specific hardware of the client device 102 and administrator device 106 will be described. FIG. 2 is a block diagram illustrating an exemplary client device 102 or administrator device 106 within the system 100 in accordance with one aspect of the present disclosure. The client device 102 and administrator device 106 can take the form of a tablet, mobile phone, smartphone, personal digital assistant, handheld computer, standalone computer, or the like. The client device 102 and administrator device 106 can have different components and do not have to necessarily contain the same. The hardware illustrated in FIG. 2 is for exemplary purposes and does not necessarily define the hardware of the client device 102 nor the administrator device 106.

In typical embodiments, the client device 102 and administrator device 106 can have a processor 204 for implementing logic, a memory 206, a display 208 and a keypad 210. The display 208 of the device can be a liquid crystal display (LCD), or any other type of display commonly used in a device. The display 208 can be touch-sensitive, and can act as an input device. The keypad 210 can be a push button numeric dialing pad (such as on a typical telephone), a multi-key keyboard (such as a conventional keyboard), or any other device for inputting textual data.

The memory 206 generally includes both volatile memory (e.g., RAM) and non-volatile memory (e.g., ROM, Flash Memory, or the like). The non-volatile portion of the memory 206 can be used to store persistent information which should not be lost when the device is powered down. The client device 102 and administrator device 106 can include an operating system (OS) 220, such as Windows CE™ or Windows Mobile™ available from Microsoft Corporation®, Android™ from Google™, BSD, iOS, Linux, OS X, QNX, Microsoft Windows, IBM z/OS, or other OS. The OS 220 can reside in the memory 206 and be executed on the processor 204.

The memory 206 can also include one or more device managers 222 for interacting with one or more I/O devices. The device managers 222 can be software installed on the client device 102 and administrator device 106. A device manager 222 can correspond to each I/O device. In addition to the device manager 222, one or more client applications 224 can be loaded into memory 206 and run on or in association with the OS 220. In the present disclosure, a client application 224 can include software, for example, a browser, for accessing content over a network including the World Wide Web.

The memory 206 can also include a collection of one or more APIs 226 for facilitating communication between the client device 102 or administrator device 10 and the validation server 104. The APIs 226 can be used to recognize and control the one or more remote devices. In this manner, the device is able to take advantage of services or functionalities of the one or more remote devices.

The client device 102 and administrator device 106 can also include a power supply 218, which can be implemented as one or more batteries, fuel cells, or other sources of electrical power. The power supply 218 might further include an external power source, such as an AC adapter or a powered docking cradle that supplements or recharges the batteries. The device can include one or more audio, visual, and/or vibratory notification mechanisms 212. The mobile device can also include a network module 216, such as a module that facilitates wireless connectivity between the device and the sources or a line connection connected into a wireline carrier. Each of the components described above can communicate through a bus.

While shown as operating on a smartphone platform, the client device 102 and administrator device 106 can be used on a standalone computer, desktop computer, laptop, or the like and is not necessarily limited to any particular device. Furthermore, the client device 102 and administrator device 106 can each have their own unique software to communicate with the validation server 104.

In one embodiment, the client device 102 can include a local cache of uniform resource locators or other content that was recently reviewed. The local cache can be stored in the memory 206. The local cache can contain approved or disapproved content. One advantage of providing a local cache can be removing multiple access requests to the same content. Depending on the size of the memory 206, the local cache can be used to store a number of different disapprovals or approvals.

Typically, software for validating the content can be downloaded onto the client device 102. Alternatively, the software can also be preinstalled. The software can reconfigure the client device such that applications 224 can be required to go through the validation server 104. The software can take control of communications on the OS 220, device managers 222, client applications 224 or APIs 226. When content is accessed by a client application 224, for example, a browser, communications can be sent through a dynamic authorization component on the client device 102 that communications with the validation server 104 and in the case of local validation, through the local cache first, as described above.

In one embodiment, the content can include pictures, text messages, voicemails, calls, or the like to prevent harmful materials from being viewed or listened on the client device 102, which are not typically associated with a uniform resource locator. For example, if a solicitation is made through a text message, the system 100 could monitor the groups or persons providing the message. In another example, if a parent using the administrator device 106 does not wish for their daughter to speak to a certain individual, they can control this through validation server 104. The local cache in the client device 102 can be used to disapprove or approve the particular person or group as well as the validation server 104.

Registration of a client device 102 can begin with opening a communication with the validation server 104. For proper registration, the client device 102 can retrieve its unique identifier such as an IP address. Alternatively, a unique identifier can be created by the validation server 104, client device 102, and/or administrator device 106 without the IP address. For example, a “magic number” can be used which can include a number generated randomly. This identifier can be associated with a user's email address or login name. The client device 102 can then send the identifier to the validation server 104 through the network. The identifier can be stored into the validation server 104 and a registration of an administrator device 106 can be paired with the identifier for future validation. If a client device 102 is not paired, the validation server 104 can provide an error message to the client device 102 that there is no corresponding administrator device 106 to review their content. In one embodiment, the client device 102 can direct the validation server 104 to contact an administrator device 106 for a pairing.

When registered and paired with an administrator device 106, the client device 102 can then begin to access content that is verified. In one embodiment, the client device 102 can open a line of communication with the validation server 104 for each piece of content searched. Alternatively, the client device 102 can communicate with the verification server 104 and keep the communication open for a period of time.

With reference now to the administrator device 106, the client applications 224 can use standard applications 224 such as SMS, MMS, email, mobile or desktop applications, or the like for monitoring content. The user of the administrator device 106 can use software having a specialized interface for providing an answer to the content access. The user of the administrator device 106 can be a supervisor, parent, guardian, or the like. To register the administrator device 106, the user can connect with the validation server 104 through the network. Once logged on, the administrator can provide their preferred way of contacting them once the client device 102 accesses content. For example, the user of the administrator device 106 can prefer to receive text messages. These settings can be stored on the validation server 104, and as will be shown in the discussion regarding the client/administrator database 122.

The user of the administrator device 106 can also register the above provided information outside their device 106. The user can also setup a chain registration such that if they cannot be located at one device they can be found at another device. In addition, the user of the administrator device 106 can designate others that can be alerted if content is accessed. For example, if the validation server 104 cannot locate the father of the user on the client device 102, then the mother can be contacted. Alternatively, both the mother and father can be contacted simultaneously.

The user of the administrator device 106 can also setup client devices 102 in which they can monitor their content. More than one client device 102 can be setup with an administrator device 106. For example, a user of an administrator device 106 can monitor each of their children. Furthermore, more than one administrator device 106 can be setup with a client device 102.

Now returning to FIG. 1, and after the client device 102 and administrator device 106 have been registered, the validation server 104 can begin to monitor content being accessed by the client device 102. The validation server 104 can include a number of modules and databases. The validation server 104 can include a validation logic module 120, administrator approval communication module 126 and recommendation engine module 128. In addition, the validation server 104 can include a client/administrator database 122, records database 124, community uniform resource locator store database 130, white list database 132, and a black list database 134. The modules and database are not limiting however and fewer or additional components can be added to the validation server 104. Furthermore, while the databases are shown to be internal to the validation server 104, these can be found outside or remote from the validation server 104 and can be communicated to through the network.

As described, the client device 102 can begin the process by accessing content on a client application 224 or the like. When a uniform resource locator is entered in, the local cache is checked to determine if the uniform resource locator was recently checked. This can remove multiple requests to the validation server 104. When the uniform resource locator is not found in the local cache, a client identifier can be retrieved from the client device 102. The identifier can be taken off the device 102 itself such as an IP address or can be part of a username login configuration. The identifier can be sent to the validation server 104 through the network.

The validation server 104 connected to the network can receive the uniform resource locator and identifier from the client device 102. The validation logic module 120 can then process this information. The module 120 can determine whether the client device 102 has a valid pairing of client devices 102 and administrator devices 106. As described above, a client device 102 registers their device and this information is stored in the client/administrator database 122. The validation server 104, however, does not typically start processing content being accessed until the client device 102 is paired with at least one administrator device 106. While being described as separate registration processes, both can be captured at the same time where client devices 102 are linked with administrator devices 106.

The validation logic module 120 can determine whether appropriate pairings have been created between client devices 102 and the administrator devices 106 by checking the client/administrator database 122 using the identifier provided by the client device 102. The module 120 can query the database 122 to receive a pairing. If no paring exists, then a proper relationship has not been set up and an error is presented to the client device 102 through the validation logic module 120 on their access request.

However, if a pairing can be found between the client device 102, a query can be made with the uniform resource locator and the client identifier to the records database 124. The records database 124 can contain information regarding received uniform resource locators that have been approved or disapproved. This can be updated dynamically as will be shown below typically through the administrator approval communication module 126. The validation logic module 120 can receive a query response back from the records database 124 indicating whether the accessed uniform resource locator has been approved or disapproved from previously stored information.

When the record indicates that the uniform resource locator has been approved or disapproved, the result can be provided back to the client device 102. On the client device 102, the result can be sent to the client application 224 which can deny or approve the content, or in the alternative, the source to which the content was accessed through. In one embodiment, if the uniform resource locator has been denied, the user of the client device 102 can send a reconsideration request back to the validation server 104. Typically, reconsideration requests can be accepted if a predetermined period of time has elapsed. For example, a reconsideration requests can be made when access to content has been denied earlier but time has passed by where both parties have cooled off. This can occur when the local cache within the client device 102 or the records database 124 shows disapproval of the content.

If a reconsideration request has been asked for or if the uniform resource locator is not found in the records database 124, the uniform resource locator can be provided to the administrator approval communication module 126. Through the module 126, a secondary approval process can be presented. This can involve a real-time approval by the administrator device 106 that can be used to approve or disapprove content.

In one embodiment, the uniform resource locator can be sent directly to the administrator device 106 and their feedback can be provided. This would leave out the use of the recommendation engine module 128. Alternatively, and to save resources, the validation server 104 can provide a recommendation to the administrator device 106 before sending a request for feedback to the administrator device 106.

To retrieve a recommendation, the recommendation request from the administrator approval communication module 126 can be sent to the recommendation engine module 128 of the validation server 104. The module 128 can include an analytics engine and use a number of databases including a community uniform resource locator store 130, white list 132, and a black list 134. One or a combination of these databases can be used to determine a recommendation for use by the administrator device 106. The recommendation engine module 128 can also use other types of information to determine a recommendation. For example, the module 128 can determine whether advertisements within the content accessed by the uniform resource located have harmful content. Graphics, text, shapes, links, and/or language can be determinative factors in addition to, or separately therefrom.

The community uniform resource locator store database 130, by way of example, can include uniform resource locators that are disapproved or approved by standards established by a neighborhood, region, country, or the like. Furthermore, the database 130 can define uniform resource locators appropriate for different ages. Age determinations can be made by the identifier received by the validation server 104 from the client device 102. This can also be stored in the client/administrator database 122 discussed earlier.

The community uniform resource locator store database 130 can be updated dynamically and frequently. While shown as being local to the validation server 104, the database 130 can be located off the server 104 and be part of a much larger content validation site. Accordingly, third party services can be available for providing the community uniform resource locator store database 130. The whitelist database 132 and blacklist database 134 can also be provided by third parties.

The recommendation engine module 128 can take the information from at least one of the community uniform resource locator store database 130, white list database 132, and black list database 134 to determine a recommendation for the administrator device 106. An algorithm for making the recommendation can include giving weights to community uniform resource locator store database 130, white list database 132, and black list database 134. The recommendation can be provide in the form of a percentage such that a higher percentage would indicate that the content should be approved while a lower percentage can indicate the content should be disapproved.

In one embodiment, the recommendation provided by the recommendation engine module 128 can be based on a priority. For example, if an urgency request is sent by the client device 102 that they need to access the content, less ambiguity in the recommendation would be provided in the percentage of approval or disapproval.

Once a recommendation is determined by the recommendation engine module 128, the recommendation can be provided to the administrator approval communication module 126. The module 126 can forward this information to the user of the administrator device 106 through the network. As discussed above, the recommendation does not have to be a complete approval or disapproval of the content being viewed. Instead, the recommendation can indicate whether approval of this uniform resource locator could potentially cause a concern or not.

On the administrator device 106, the recommendation from the validation server 104 can be evaluated. This recommendation can be evaluated in real or run time such that when content is accessed on the client device 102, the recommendation to the administrator device 106 can show up quickly thereafter. An interface provide as a client application 224 on the administrator device 106 can be used to approve or reject the content. The recommendation can be provided as text, email, or the like and the response to the recommendation by the administrator device 106 can be provided through similar application 224.

If the answer from the administrator device 106 includes an approved or disapproved answer, the answer can be sent to the administrator approval communication module 126 which can then forward the answer to the validation logic module 120. From there, the answer can be provided to the client device 102 which can be handled on the device 102 to approve or disapprove the content.

Alternatively, the user of the administrator device 106 can provide a maybe answer. In this third option, the uniform resource locator can be approved dependent on other factors not related to the content within the uniform resource locator. For example, the user of the administrator device 106 can provide a maybe answer depending on whether a user of the client device 102 finished their homework or completed their chores. Homework completion can be verified through the validation server 104 connected to a school server, not shown. When the user of the client device 102, has completed their tasks, then the validation server 104 can approve the maybe answer given by the administrator device 106. Alternatively, the maybe answer can be disapproved if the user did not complete their tasks. The approval or denial can then be provided back to the client device 102.

Once a uniform resource locator has been approved or disapprove, the records database 124 can be updated with the information. This can provide a dynamic update of the records database 124 that can be specific to the client/administrator pairing. In addition, maybe answers provided by the administrator device 106 can be stored as well. This could remove the use of the recommendation engine module 128 to provide a recommendation to the administrator device 106.

Turning to FIG. 3, a flow chart illustrating processes for validating the uniform resource locator on the client device 102 in accordance with one or more aspects of the present disclosure is provided. At block 300, the processes for uniform resource locator validation on a client device 102 can begin. Typically the processes begin when a user is searching for content on their browser. Alternatively, other types of content can be validated by the validation server 104 as discussed above such as people or groups the user is speaking, texting, or communicating with.

At block 302, a uniform resource locator can be received to access content. The client device 102, in one embodiment, can include local cache. The local cache can store previously approved or disapproved content up. In this way, the client device 102 would not have to continuously query the validation server 104. At decision block 304, a determination can be made whether the received uniform resource locator is located within local cache.

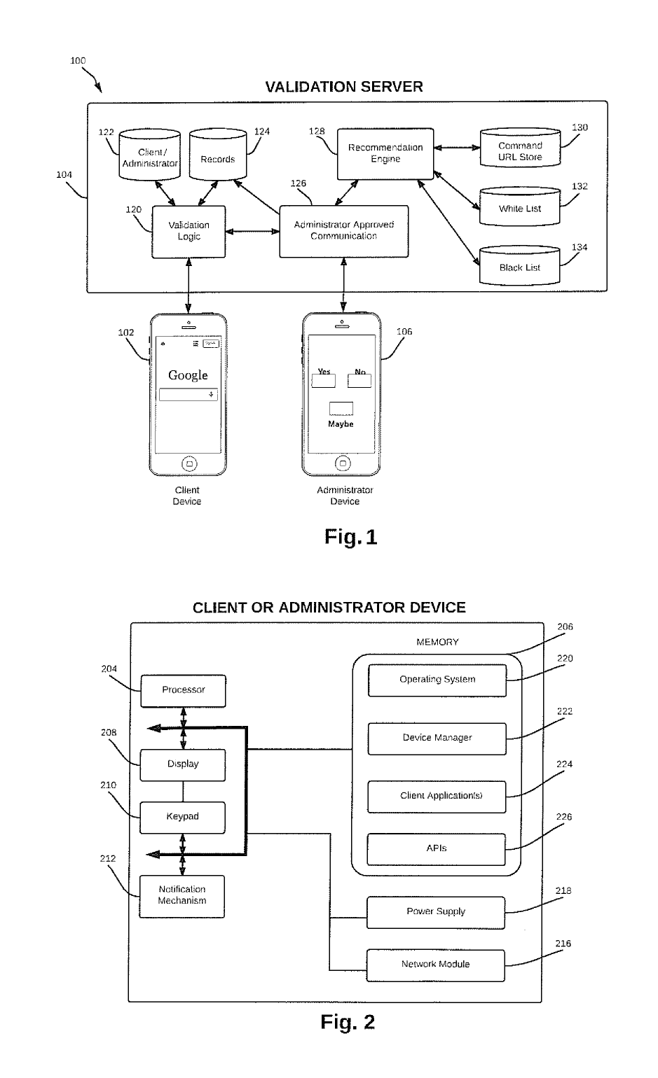

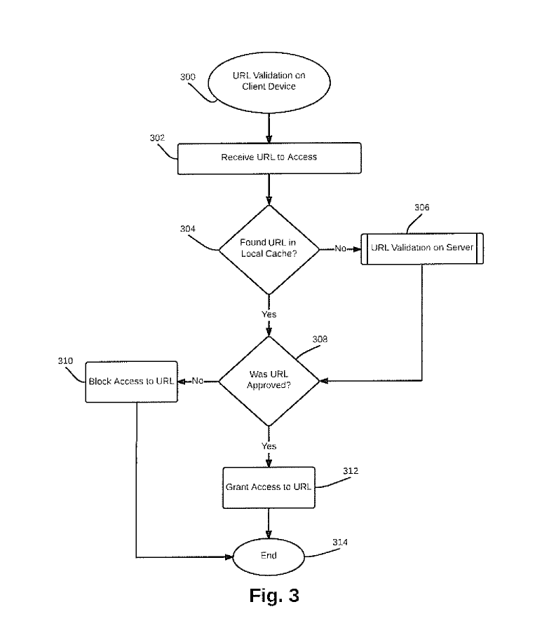

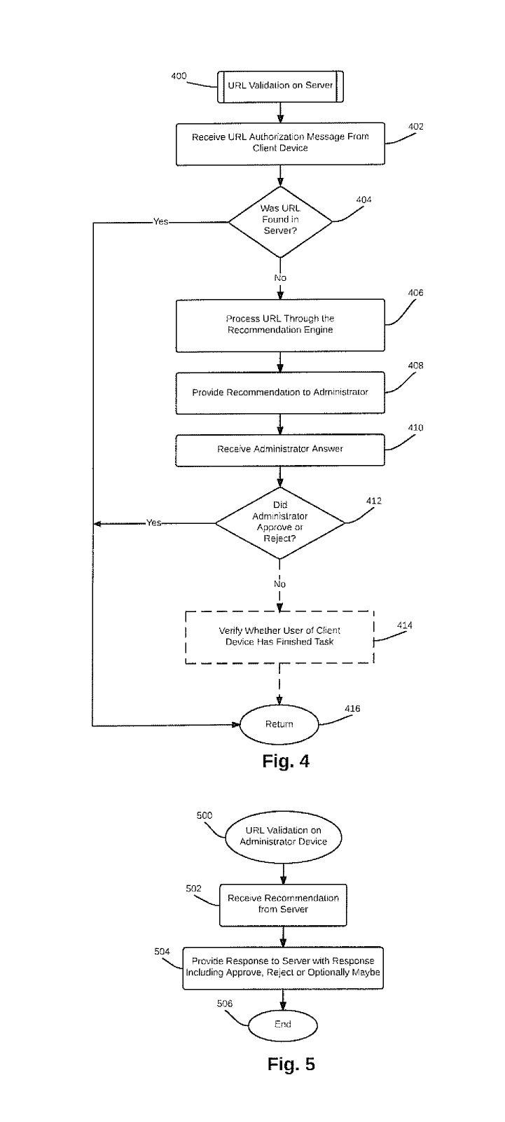

When the uniform resource locator is not found in local cache on the client device 102, at block 306, the uniform resource locator can be processed on the validation server 104. This will be described in more details in FIG. 4. If the uniform resource locator is found within the local cache, then the process goes to decision block 308. The uniform resource locator, at this process, will have been approved or disapproved. If the uniform resource locator has not been approved, access is blocked by the running program, for example, a web browser, at block 310. If the uniform resource locator is approved, access is granted to the content at block 312. The processes can end at block 314.

With reference now to FIG. 4, a flow chart illustrating processes for validating the uniform resource locator on the validation server 104 in accordance with one or more aspects of the present disclosure is provided. The processes for content validation on the validation server 104 can begin at block 400. At block 402, the validation server 104 can receive the uniform resource locator authorization message from the client device 102. This message can include an identifier of the client device 102, for example, an IP address.

While not shown, the received identifier can be used to determine if there is an associated administrator device 104 by accessing the client/administrator database 122. If there is no paired administrator device 106, an error can be provided back to the client device 102 letting the user of the client device 102 know that they should contact their administrator.

At decision block 404, the validation server 104 can determine whether the uniform resource locator was found on the server 104. As described earlier, this can be determined by accessing the records database 124 with the received identifier from the client device 102. Using this identifier, the records database 124 can provide whether the uniform resource locator was found and whether it was approved or disapproved. If the uniform resource locator was found, the processes return to FIG. 3 at block 416.

Alternatively and when the record does not indicate whether the uniform resource locator is approved or disapproved, the uniform resource locator is processed through the recommendation engine module 128 at block 406. The recommendation engine module 128 can then generate a recommendation and provided it to the administrator approval communication module 126 of the validation server 104.

At block 408, the recommendation can be provided to the administrator device 106. The processes performed by the administrator device 106 are discussed in FIG. 5. At block 410, the administrator device 106 can provide an answer to the validation server 104. This can be through a number of different programs or services available on the administrator device 106 such as text, email, or the like.

At decision block 412, a determination is made on whether the user of the administrator device 106 approved or rejected the uniform resource locator and its contents. If the user approved or rejected the contents, the processes return to FIG. 3 at block 416. When a maybe answer was provided by the administrator device 106, the process continues to block 414 where the validation server 104 can verify whether the user of the client device 102 has finished their tasks. This can be performed by having a network communication with a school server such that homework items can be checked. Other tasks can be checked as well. For example, the verification server 104 can contact another device to ensure that the user of the client device 102 has completed their chores. The processes can return to FIG. 3 at block 416. At block 416 of FIG. 4, the processes return with either an approved or disapproved uniform resource locator.

FIG. 5 is a flow chart illustrating processes for validating the uniform resource locator on the administrator device 106 in accordance with one or more aspects of the present disclosure. The processes can begin at block 500. At block 502, the administrator device 106 can receive a recommendation from the validation server 104. The validation server 104, as shown previously, can use a recommendation engine module 128 to come up with the recommendation.

In return, and at block 504, the administrator device 106 can provide a response to the validation server 104 based on the recommendation. The answer can include approval or disapproval of the uniform resource locator. In addition, the answer can include a maybe answer discussed above. The processes can end at block 506. As shown, this minimizes the responsibilities of the administrator.

The data structures and code, in which the present disclosure can be implemented, can typically be stored on a non-transitory computer-readable storage medium. The storage can be any device or medium that can store code and/or data for use by a computer system. The non-transitory computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the disclosure can be embodied as code and/or data, which can be stored in a non-transitory computer-readable storage medium as described above. When a computer system reads and executes the code and/or data stored on the non-transitory computer-readable storage medium, the computer system performs the methods and processes embodied as data structures and code and stored within the non-transitory computer-readable storage medium. Furthermore, the methods and processes described can be included in hardware modules. For example, the hardware modules can include, but are not limited to, application-specific integrated circuit (ASIC) chips, field-programmable gate arrays (FPGAs), and other programmable-logic devices now known or later developed. When the hardware modules are activated, the hardware modules perform the methods and processes included within the hardware modules.

The technology described herein can be implemented as logical operations and/or modules. The logical operations can be implemented as a sequence of processor-implemented executed steps and as interconnected machine or circuit modules. Likewise, the descriptions of various component modules can be provided in terms of operations executed or effected by the modules. The resulting implementation is a matter of choice, dependent on the performance requirements of the underlying system implementing the described technology. Accordingly, the logical operations making up the embodiment of the technology described herein are referred to variously as operations, steps, objects, or modules. It should be understood that logical operations can be performed in any order, unless explicitly claimed otherwise or a specific order is inherently necessitated by the claim language.

Various embodiments of the present disclosure can be programmed using an object-oriented programming language, such as SmallTalk, Java, C++, Ada or C#. Other object-oriented programming languages can also be used. Alternatively, functional, scripting, and/or logical programming languages can be used. Various aspects of this disclosure can be implemented in a non-programmed environment, for example, documents created in HTML, XML, or other format that, when viewed in a window of a browser program, render aspects of a GUI or perform other functions. Various aspects of the disclosure can be implemented as programmed or non-programmed elements, or any combination thereof.

The foregoing description is provided to enable any person skilled in the relevant art to practice the various embodiments described herein. Various modifications to these embodiments will be readily apparent to those skilled in the relevant art, and generic principles defined herein can be applied to other embodiments. Thus, the claims are not intended to be limited to the embodiments shown and described herein, but are to be accorded the full scope consistent with the language of the claims, wherein reference to an element in the singular is not intended to mean “one and only one” unless specifically stated, but rather “one or more.” All structural and functional equivalents to the elements of the various embodiments described throughout this disclosure that are known or later come to be known to those of ordinary skill in the relevant art are expressly incorporated herein by reference and intended to be encompassed by the claims. Moreover, nothing disclosed herein is intended to be dedicated to the public regardless of whether such disclosure is explicitly recited in the claims.

What is claimed is:

1. A method for approving content being accessed on a device, comprising:
receiving a request to access the content from the device;
allowing access to the content when a record associated with the device shows approval of the content and blocking access to the content when the record shows disapproval of the content;
retrieving a recommendation to access the content when the record is silent to the content;
providing the recommendation to an administrator device;
receiving a response from the administrator device based on the recommendation; and
allowing access to the content when the response shows approval of the content and blocking access to the content when the response shows disapproval of the content.

2. The method of claim 1, comprising retrieving the record associated with the device by accessing a database storing relational information between a user of the device and a user of the administrator device.

3. The method of claim 1, wherein allowing access to the content when the record associated with the device shows approval of the content and blocking access to the content when the record shows disapproval of the content comprises providing the device an approval message or disapproval message.

4. The method of claim 1, wherein retrieving a recommendation to access the content when the record is silent to the content comprises:
accessing at least one of a community content store, white list, and black list; and
analyzing the content with the at least one community content store, white list, and black list to select the recommendation.

5. The method of claim 4, wherein analyzing the content with the at least one community content store, white list, and black list to select the recommendation comprises differentiating age groups with the content.

6. The method of claim 1, wherein providing the recommendation to the administrator device comprises sending a pre-established notification to the administrator device.

7. The method of claim 6, wherein sending the pre-established notification to the administrator device comprises delivering at least one of an SMS, MMS, email, and notification through a mobile or desktop application to the administrator device.

8. The method of claim 1, wherein receiving the response from the administrator device based on the recommendation comprises receiving at least one of an SMS, MMS, email, and response through a mobile or desktop application delivered by the administrator device.

9. The method of claim 1, wherein allowing access to the content when the response shows approval of the content and blocking access to the content when the response shows disapproval of the content comprises providing the device an approval message or disapproval message.

10. The method of claim 1, wherein allowing access to the content when the response shows approval of the content and blocking access to the content when the response shows disapproval of the content comprises determining whether a user of the device has completed a task.

11. The method of claim 1, comprising providing the recommendation to a secondary administrator device when the administrator device fails to provide a response.

12. A system for monitoring content comprising:
a client device accessing the content through a uniform resource locator;
a validation server receiving the uniform resource locator from the client device and providing a recommendation regarding the content referenced by the uniform resource locator; and
an administrator device receiving the recommendation and providing the client device through the validation server with a response based on the recommendation, the response indicating whether the content referenced by the uniform resource locator has been approved or disapproved.

13. The system of claim 12, wherein the client device performs a search for validating the content through the uniform resource locator locally before providing the uniform resource locator to the validation server.

14. The system of claim 12, wherein the client device is registered in the validation server by sending an identifier of the client device to the validation server.

15. The system of claim 12, wherein the validation server provides the recommendation by analyzing the content based on at least one of advertisements, graphics, text, shapes, links, and language within the content.

16. The system of claim 12, wherein the administrator device provides the response based on the recommendation and whether a user of the client device completes a task.

17. The system of claim 16, wherein the task is homework setup through a school server connected to the validation server.

18. The system of claim 12, wherein the client device receives the response through the validation server and the client device denies or approves access to the content.

19. A content validation server comprising:
at least one processor; and
a memory operatively coupled to the processor, the memory storing program instructions that when executed by the processor, causes the processor to:
receive a uniform resource locator from a client device;
generate a recommendation for the uniform resource locator;
provide the recommendation to an administrator device;
receive a response from the administrator device based on the recommendation; and
allow or deny access to the uniform resource locator for the client device based on the response.

20. The content validation server of claim 19, wherein receiving the uniform resource locator from the client device occurs after a website is accessed on the client device.
